(19) United States
(12) Patent Application Publication
(10) Pub. No.: US 2018/0230292 A1
(43) Pub. Date: Aug. 16, 2018

(54) COMPOUNDS CONTAINING BLUE LIGHT BLOCKING ADDITIVE

(71) Applicant: PolyOne - Shanghai, China, Shanghai (CN)

(72) Inventors: Qian WANG, Shanghai (CN); Wenyu SHANG, Shanghai (CN); Mengge LIU, Shanghai (CN)

(21) Appl. No.: 15/751,820

(22) PCT Filed: Aug. 11, 2016
(86) PCT No.: PCT/CN2016/094598

§ 371 Date: Feb. 9, 2018

(30) Foreign Application Priority Data
Aug. 12, 2015 (CN) 201510492680.8

(51) Int. Cl. C08K 5/3445; C08G 64/00; C08K 5/3475; C08K 5/3437; C08K 5/01

(52) U.S. Cl. CPC C08K 5/3445; C08G 64/00; C08K 5/01; C08K 5/3437; C08K 5/3475

(57) ABSTRACT

Blue light is absorbed within thermoplastic polymer by use of organic colorants which both limit transmittance of light at 430-450 nm wavelengths to and continue transmittance of light of more than 85% at above 560 nm wavelengths. In 430-450 nm, with the different loadings of various organic colorants having various transmittances at 430-450 nm, the transmittance of the polymer can also be adjusted to meet any desired blue light transmittance level.

### FIELD OF THE INVENTION

This invention relates to thermoplastic compounds containing blue light absorbers and uses of those compounds.

### BACKGROUND OF THE INVENTION

Plastic has taken the place of other materials in a variety of industries. In the packaging industry, plastic has replaced glass to minimize breakage, reduce weight, and reduce energy consumed in manufacturing and transport. In other industries, plastic has replaced metal to minimize corrosion, reduce weight, and provide color-in-bulk products.

It has been determined that blue light, such as from light emitting diode (LED) displays used in electronic equipment, can adversely affect users of such electronic equipment. Recent research has shown that levels of melatonin, the hormone which regulates sleep, are disrupted in the human brain because of use of LED-equipped devices in hours previously devoted to darkness and sleep. The amount of blue light from electronic equipment having LED displays is not as readily apparent as when cathode ray tube televisions were viewed without any other light source. That blue glow coming from the television room may no longer be as noticeable, but the problem remains that blue light is more energetic and potential damaging to the human eye and otherwise a disrupter of sleeping patterns before modern life made LED usage ubiquitous.

### SUMMARY OF THE INVENTION

What the art needs is at least one colorant which not only blocks a variable but controlled amount of blue light but is compatible in a polymer to maximize translucency approaching transparency of visible non-blue light through a polymeric article made using the polymer compound.

The present invention concerns specific selection of certain organic colorants which absorb blue light but which retain as much transparency as possible in the non-blue visible spectrum to be useful for polymeric articles, such as eyeglasses to be worn when using self-lighted electronic equipment displays.

More specifically, whether playing a video game on a tablet computer or typing a patent application on a laptop computer or watching a horror movie on a large screen television, use of eyeglasses or filters on the electronic equipment displays can benefit from a variable but controllable amount of the blue-light-blocking organic colorants dissolved in the polymer resin of which the eyeglasses or filters on the displays are made.

One aspect of the invention is a thermoplastic compound, comprising: (a) thermoplastic polymer; (b) organic colorant compatible with the thermoplastic polymer and absorbing blue light; and (c) optional functional additives, wherein the compound when tested according to Transmittance Test Method in using Perkin-Elmers lambda 650 UV-VIS Spectrometer and a test sample of dimension of x=20 mm; y=25 mm; and z=2 mm results in the compound having less than about 80% transmittance at wavelengths of 250-450 nm and greater than about 85% transmittance at wavelengths of greater than about 560 nm.

Features will become apparent from a description of the embodiments of the invention.

### BRIEF DESCRIPTION OF THE DRAWING

FIG. 1 is a chart of transmittance of the Control Example, the Comparative Examples, and the Examples of the Invention.

### EMBODIMENTS OF THE INVENTION

Compounds and Uses of Compounds

Candidate thermoplastic polymers can be polypropylene (PP); polyethylene (PE); ethylene vinyl acetate (EVA); polyethylene terephthalate (PET); polycarbonate (PC); acryonitrile-butadiene-styrene (ABS); acetal or polyoxymethylene (POM); polyamide (PA); polyphenylene sulfide (PPS); polylactic acid (PLA); polymethylmethacrylate (PMMA); polystyrene (PS); any copolymer of any of them; or combinations thereof. Polycarbonate is desirable for use because of its natural clarity, with optical grade polycarbonate being preferable if economic in cost for the particular polymeric article made.

Organic colorants need to be selected by those having ordinary skill in the art, without undue experimentation, based on three criteria: (a) compatibility, desirably miscibility, and preferably solubility of the colorant in the thermoplastic polymer in order to maximize transmittance and retain maximum clarity at those wavelength regions other than blue light; (b) considerable absorption of blue light in the wavelength region of about 430-450 nm; and (c) minimal absorption of light in the wavelength region of greater than 450 nm, especially greater than 560 nm. The criteria of (a) and (c) are inter-related and distinguishable from the criterion of (b) in which minimal light transmittance need not address compatibility.

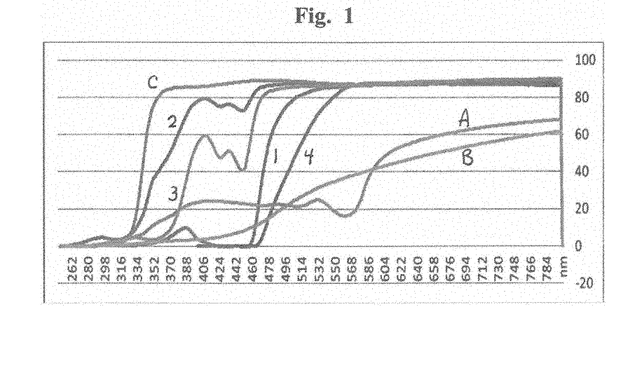

As seen in FIG. 1 based on the Examples below, it is possible based on knowledge of this invention for a person having ordinary skill in the art to select from among commercially available organic colorants to select those colorants meeting the three criteria identified above. Moreover, a person having ordinary skill in the art, based on the examples below can tailor the amount of blue light transmittance in the wavelength region of about 430-450 nm to be any amount from 0% to as much as about 80% and any percentage in between those extremes. Preferably, the amount of blue light transmittance can be varied to any such percentage by use of more than one organic colorant meeting the three criteria above, but controllable at that percentage by the formulator of the polymer compound. It is understood that any percentage between 0% to 80%, achieved by a single organic colorant or any combination of more than one organic colorant is specifically disclosed as suitable for use in the polymer compound to achieve the benefit of this invention. Moreover, any range of percentages between 0% and 80% is disclosed as if listed consecutively herein.

The compound can also contain one or more conventional plastics additives in an amount that is sufficient to obtain a desired processing or performance property for the thermoplastic compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers, fibers, and extenders; flame retardants; smoke suppressants; impact modifiers; initiators; lubricants; colorants and dyes; plasticizers; processing aids; release agents; slip and anti-blocking agents; stabilizers; stearates; viscosity regulators; waxes; catalyst deactivators, and combinations of them.

Table 1 shows acceptable, desirable, and preferable ranges of ingredients useful in the present invention, all expressed in weight percent (wt. %) of the entire compound. The compound can comprise, consist essentially of, or consist of any one or more of the thermoplastic polymers and organic blue light absorber(s), in combination with any one or more optional functional additives. Any number between the ends of the ranges is also contemplated as an end of a range, such that all possible combinations are contemplated within the possibilities of Table 1 as candidate compounds for use in this invention.

TABLE 1

| Ingredient | | | |
|---|---|---|---|
| (Percent by Weight) | Acceptable | Desirable | Preferable |
| Thermoplastic Polymers(s) | 70-98 | 80-99 | 90-99.5 |
| Organic Blue Light | 0.00001-2 | 0.001-1 | 0.01-0.5 |
| Absorber(s) | | | |
| Optional Functional | 0-30 | 0-20 | 0-10 |
| Additive(s) | | | |

Processing

The preparation of compounds of the present invention is uncomplicated. The compound of the present can be made in batch or continuous operations. The compound can be formed from all ingredients added together or some of the ingredients being first formed into a masterbatch for later dilution or “let down” into thermoplastic resin.

Mixing in a continuous process typically occurs in a single or twin screw extruder that is elevated to a temperature that is sufficient to melt the polymer matrix with addition of other ingredients either at the head of the extruder or downstream in the extruder. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is capable of operating at a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com), one can make articles of any conceivable shape and appearance using compounds of the present invention.

### USEFULNESS OF THE INVENTION

Compounds of the invention can be made into any extruded, molded, calendered, thermoformed, or 3D-printed article.

Candidate end uses for such finally-shaped thermoplastic articles are eyeglasses, windows, electronic equipment display filters, and other polymer articles in which there is a desire to block blue light while also permitting non-blue light to be transmitted through the polymer article.

Examples explain the performance of the compound containing various organic colorants in polycarbonate.

### EXAMPLES

Examples 1, 2, 3, and 4 and Comparative Examples A and B were all compared with the Control C.

Table 2 shows the ingredients, their chemistry, and their commercial sources. Table 3 shows the conditions under which test materials were made. Table 4 shows the formulations and test results. FIG. 1 is a graphical display of the results of Table 4.

The Test shown in Table 4 used transmittance in using Perkin-Elmers lambda 650 UV-VIS Spectrometer Test Method to determine the transmittance at wavelengths of 430-450 nm and the transmittance at wavelengths of greater than about 560 nm.

TABLE 2
Ingredients

| Ingredient | | | | Commercial | Source | |
|---|---|---|---|---|---|---|
| Name | Purpose | Brand Name | Generic Name | Source | Location | CAS No. |
| PC | Polymer resin | Panlite L-1250Y | Polycarbonate | Teijin | Shanghai | 25037-45-0 |
| UVA 234 | UV absorption | Jinwei 234 | Benzotriazole | Jinwei | Shanghai | 70321-86-7 |
| UVA UV-P | UV absorption | Tinuvin P | Benzotriazole | BASF | Shanghai | 2440-22-4 |
| Yellow G | Colorant | Macrolex | Quinophthalone | Lanxess | Shanghai | 92874-95-8 |
| Yellow 3G | Colorant | Macrolex | Pyrazolone | Lanxess | Shanghai | 4702-90-3 |
| Orange R | Colorant | Macrolex | Methine (Styryl) | Lanxess | Shanghai | 842-07-9 |
| Red SR2P | Colorant | Cinilex DPP | Diketo-Pyrrolo- | Cinic | Shanghai | 84632-65-5 |
| | | | Pyrrol Red | | | |
| Yellow HRPA | Colorant | CROMOPHTAL | Azo salt | BASF | Shanghai | 154946-66-4 |

The Control and each of Examples 1-4 and Comparative Examples A and B were made by making a masterbatch by extrusion and then molding of the masterbatch with let down into resin to make test plaques (20 mm×25 mm×2 mm) according to the conditions of Table 3.

TABLE 3
Injection Conditions
Temperature

| | |
|---|---|
| feeding zone | 280° C. |
| Zone 3 | 290° C. |
| Zone 2 | 285° C. |
| Zone 1 | 285° C. |
| Nozzle | 285° C. |

TABLE 4

| Wt. % | Example 1 | Example 2 | Example 3 | Example 4 | Comp. Ex. A | Comp. Ex. B | Control C |
|---|---|---|---|---|---|---|---|
| PC | 98.725 | 99.9968075 | 99.93175 | 98.1875 | 98.75 | 98.365 | 100 |
| UVA 234 | 1 | 0.003 | 0.06 | 0 | 0 | 0 | 0 |
| UVA UV-P | 0 | 0 | 0 | 0 | 1 | 1 | 0 |
| Yellow G | 0.25 | 0.000175 | 0.0075 | 0.75 | 0 | 0 | 0 |
| Yellow 3G | 0.025 | 0.0000175 | 0.00075 | 0.0125 | 0 | 0 | 0 |
| Orange R | 0 | 0 | 0 | 0.05 | 0 | 0 | 0 |
| Red SR2P | 0 | 0 | 0 | 0 | 0.25 | 0.01 | 0 |
| Yellow HRPA | 0 | 0 | 0 | 0 | 0 | 0.625 | 0 |
| Total | 100 | 100 | 100 | 100 | 100 | 100 | 100 |
| Color | Yellow | Yellow | Yellow | Orange | Orange | Yellow | No color |
| Compatibility of | Yes | Yes | Yes | Yes | No | No | NA |
| Colorants with | | | | | | | |
| Polycarbonate | | | | | | | |
| Transmittance at 430- | 0% | 70-75% | 40-50% | 0% | 21-23% | 7-10% | 88-90% |
| 450 nm (approx.) | | | | | | | |
| Transmittance at | 90% | 90% | 90% | 90% | 20-65% | 38-60% | 90% |
| >560 nm (approx.) | | | | | | | |

As seen in FIG. 1, Control C transmits blue light in the 430-450 wavelength range and also throughout the visible light wavelengths above 450 nm. Comparative Examples A and B failed the >560 nm portions of the transmittance test. Examples 1-4 all passed the >560 nm portions of the transmittance tests.

Moreover, with Examples 1-3, all yellow organic colorants, one can achieve any percentage transmittance between 0% and 800% (as if fully rewritten herein) by using one or more of the organic colorants of Examples 1-3. Example 4 demonstrated that an organic colorant of a different color can also be found and used to alter the yellowness of any of Examples 1-3 and also achieve any percentage transmittance between 0% and 80% (as if fully rewritten herein).

Also, Examples 1 and 4 demonstrate that two different colors can be found, each having approximately 0% transmittance in the 430-450 nm wavelength range if all blue light is to be blocked by a polymer compound otherwise clearly transmitting non-blue visible light.

The difference in types of colorants used in the same polycarbonate polymer determined the success or failure of the blocking of blue light and also the essentially clear transmittance of visible light above 560 nm. Even though the color of the polymer compound of Examples 1-4 and Comparative Examples A-B were either yellow or orange, the absorption of blue light was varied among the results of Examples 1-4 but capable of control to achieve any percentage transmittance between approximately 0% and 80% in 430-450 nm wavelength range.

The invention is not limited to the above embodiments. The claims follow.

What is claimed is:

1. A thermoplastic compound, comprising:
(a) thermoplastic polymer,
(b) organic colorant compatible with the thermoplastic polymer and absorbing blue light; and
(c) optional functional additives,
wherein the compound when tested according to Transmittance Test Method in using Perkin-Elmers lambda 650 UV-VIS Spectrometer and a test sample of dimension of x=20 mm; y=25 mm; and z=2 mm results in the compound having less than about 80% transmittance at wavelengths of 250-450 nm, and greater than about 85% transmittance at wavelengths of greater than about 560 nm.

2. The compound of claim 1, wherein the range of transmittance at 430-450 nm is determined by the number and type of organic colorant used, and wherein that transmittance for the compound at 430-450 nm can be approximately 0% to about 80% and any percentage in between.

3. The compound of claim 2, wherein the color of the polymer compound can be yellow or orange.

4. The compound of claim 3, wherein the thermoplastic polymer is polycarbonate, polymethylmethacrylate, or polystyrene.

5. The compound of claim 1, wherein the organic colorant is selected based on compatibility with the thermoplastic polymer, considerable absorption of light in the wavelength region of 430-450 nm, and minimal absorption of light in the wavelength region of greater than 560 nm.

6. The compound of claim 5, wherein the organic colorant is present in an amount of 0.00001 weight percent to 2 weight percent of the compound.

7. The compound of claim 5, wherein the organic colorant is present in an amount of 0.01 weight percent to 0.5 weight percent of the compound.

8. The compound of claim 3, wherein the organic colorant to achieve a yellow compound is a combination of Quinophthalone and Pyrazolone.

9. The compound of claim 3, wherein the organic colorant to achieve an orange compound is a combination of Quinophthalone, Pyrazolone, and Methine (Styryl).

10. A thermoplastic article made from the compound of claim 1.

11. The article of claim 10, wherein the organic colorant is selected based on compatibility with the thermoplastic polymer, considerable absorption of light in the wavelength region of 430-450 nm, and minimal absorption of light in the wavelength region of greater than 560 nm, and
wherein the organic colorant is present in an amount of 0.00001 weight percent to 2 weight percent of the compound.

12. The article of claim 10, wherein the article is finally shaped as eyeglasses, windows, electronic equipment display filters, or other polymer articles in which there is a desire to block blue light while also permitting non-blue light to be transmitted through the polymer article.

13. The compound of claim 2, wherein the organic colorant is selected based on compatibility with the thermoplastic polymer, considerable absorption of light in the wavelength region of 430-450 nm, and minimal absorption of light in the wavelength region of greater than 560 nm.

14. The compound of claim 3, wherein the organic colorant is selected based on compatibility with the thermoplastic polymer, considerable absorption of light in the wavelength region of 430-450 nm, and minimal absorption of light in the wavelength region of greater than 560 nm.

15. The compound of claim 4, wherein the organic colorant is selected based on compatibility with the thermoplastic polymer, considerable absorption of light in the wavelength region of 430-450 nm, and minimal absorption of light in the wavelength region of greater than 560 nm.

16. A thermoplastic article made from the compound of claim 2.

17. A thermoplastic article made from the compound of claim 3.

18. A thermoplastic article made from the compound of claim 4.

19. A thermoplastic article made from the compound of claim 8.

20. The article of claim 11, wherein the article is finally shaped as eyeglasses, windows, electronic equipment display filters, or other polymer articles in which there is a desire to block blue light while also permitting non-blue light to be transmitted through the polymer article.
